(19) United States
(12) Patent Application Publication
(10) Pub. No.: US 2002/0050739 A1
(43) Pub. Date: May 2, 2002

(54) Method and device for controlling wheel brakes

(76) Inventors: Georg Koepff, Vaihingen/enz (DE); Reinhard Weiberle, Vaihingen/enz (DE); Bernd Kesch, Hemmingen (DE)

Correspondence Address: KENYON & KENYON, ONE BROADWAY, NEW YORK, NY, 10004, US

(21) Appl. No.: 09/912,666

(22) Filed: Jul. 23, 2001

(30) Foreign Application Priority Data
Jul. 26, 2000 (DE) 100 36 287.7

(51) Int. Cl. B60T 8/88

(52) U.S. Cl. 303/122.09

(57) ABSTRACT

A method and a device for controlling wheel brakes is proposed. To improve the availability and to fulfill legal requirements imposed on an electrical braking system, a control of the valves derived from a second power circuit independent of the first one is provided in the event of a fault, via which the braking pressure in the at least one wheel brake can be set even in the event of a fault.

### FIELD OF THE INVENTION

The present invention relates to a method and a device for controlling wheel brakes.

### BACKGROUND INFORMATION

Modem braking systems are brake-by-wire systems with electrohydraulic, electropneumatic and/or electromotive activation of the individual wheel brakes. One example for such a braking system is described in German Published Patent Application No. 198 07 366. This publication describes an electrohydraulic braking system which functions as a power brake system in normal operation, however, it has a backup level as muscular-energy assisted braking system in emergency operation. For implementation, shut-off valves which are open when de-energized are connected between the brake master cylinder and the wheel brake cylinders of at least two wheels, the shut-off valves being energized and thus closed in normal operation and open in emergency operation in order to enable the driver to have hydraulic feedthrough from the brake pedal to the wheel brake cylinders.

The electrohydraulic brake actuator used has a high-pressure hydraulic pump and a high-pressure hydraulic accumulator. The pressure produced by the hydraulic pump and possibly accumulated can be fed to the wheel cylinder or wheel cylinders via braking pressure buildup valves. The built up wheel braking pressure is reduced via one outlet valve per wheel brake, the outlet valve being connected to a reservoir. The actuation of the valves is dependent on the extent of pressure on the brake pedal by the driver. If a fault occurs in the system, the shut-off valve is opened and the driver is allowed feedthrough to the wheel brake via the master brake cylinder hydraulically.

Since the provided backup level signifies considerable additional expense with regard, for example, to line length, the check of its availability, etc., an endeavor is made to develop devices, with the aid of which such a hydraulic backup level can be completely dispensed with. German Published Patent Application No. 195 48 207 (U.S. Pat. No. 5,934,767) describes an example of such a device. This known device without a hydraulic or mechanical backup level is, however, not designed with two complete circuits so that the legal requirements for a vehicle braking system might not be met.

Electrically controlled braking systems are elaborate structures not only with regard to the actuator but also with respect to the control structure with a view toward the necessary operational reliability. One such example is described in German Published Patent Application No. 196 34 567 (U.S. Pat. No. 5,952,799) in which a control module is assigned to a wheel group having an electrically operable actuator which activates the wheel brakes and which is connected via a communication system to other control modules for the processing and/or modification of the driver's braking intention. In this connection, German Published Patent Application No. 198 26 131 describes various approaches for the design of such control modules which also permit a possibly limited operation of the control module in the event of a fault and thus the operation of the actuator without an additional backup level (fail operational).

In electrohydraulic braking systems, various procedures are known for the recognition of faults in the components of the hydraulic actuator, e.g., in the valve arrangements or the pressure supply, which are also used in connection with the designs described below. Examples of these are described in detail in German Published Patent Application No. 198 07 366, German Published Patent Application No. 198 07 367 and/or German Published Patent Application No. 198 07 368.

### SUMMARY OF THE INVENTION

The procedure described below results in substantially increased reliability of at least one brake circuit of a vehicle braking system and in so doing meets the legal requirement for a dual circuit both on a hydraulic and on an electrical level.

It is particularly advantageous that a hydraulic backup level is dispensed with and the demands on the master brake cylinder are lower. This results in increased crash safety through lower pedal intrusion in a front-end collision of the vehicle, as well as increased flexibility in vehicle design.

Of particular advantage is the division into a front axle brake circuit and a rear axle brake circuit, the actuators being assigned with increased availability to at least one of these brake circuits, the front axle brake circuit in particular, as a final control element.

It is advantageous that the increased availability is attained by appropriate design of the actuators and their power supply, a redundance in the area of the pressure supply and/or at least in parts of the valve arrangement permitting at least several braking operations to be performed in the event of a failure of the hydraulic and/or electrical system.

It is further advantageous that the brake circuit is divided both with regard to the hydraulic system as well as with regard to the electrical system, the front axle brake circuit advantageously having a higher availability in particular.

### BRIEF DESCRIPTION OF THE DRAWINGS

FIG. 1 is a first illustration of a first embodiment of the electrical and electronic system arrangement and an associated actuator.

FIG. 2 is a second illustration of the first embodiment of the electrical and electronic system arrangement and an associated actuator.

FIG. 3 is a first illustration of a second embodiment according to the present invention.

FIG. 4 is a second illustration of the second embodiment according to the present invention.

FIG. 5 is a third illustration of the second embodiment according to the present invention.

FIG. 6 is a first illustration of a third embodiment according to the present invention.

FIG. 7 is a second illustration of the third embodiment according to the present invention.

FIG. 8 is a third illustration of the third embodiment according to the present invention.

FIG. 9 is a fourth illustration of the third embodiment according to the present invention.

FIG. 10 is a fifth illustration of the third embodiment according to the present invention.

FIG. 11 shows a first flow chart that describes an emergency procedure on the basis of two of these embodiments.

FIG. 12 shows a second flow chart that describes the emergency procedure on the basis of two of these embodiments.

### DETAILED DESCRIPTION

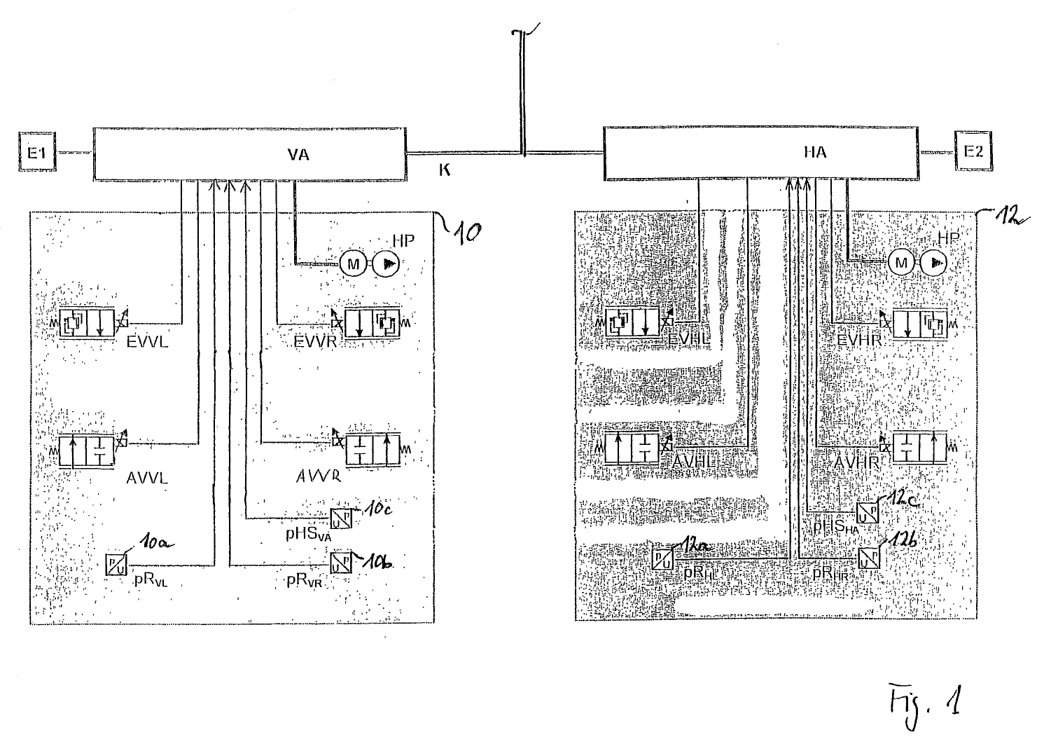

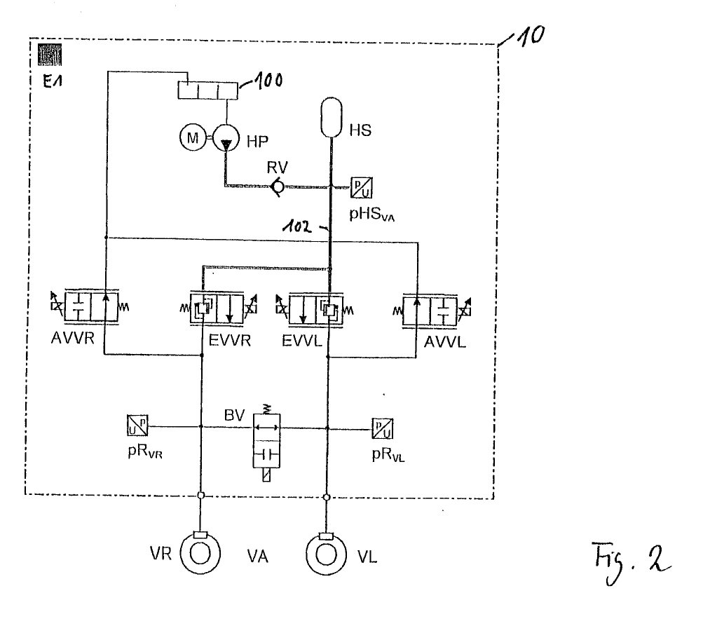

FIG. 1 shows a control module VA which controls the front axle brakes of a vehicle, the control module containing at least one computing unit (not illustrated). The control module, the computer in particular, is supplied with current by a first electrical power circuit E1. Connected to control module VA is an actuator 10 which controls the braking pressure in the front wheel brakes. In addition, a control module HA is provided for the rear wheel brakes, likewise equipped with at least one computing unit, to which is connected an actuator 12 which controls the braking pressure in the rear wheel brakes. Control module HA is supplied by a second electrical power circuit E2 which is in independent of the first electrical power circuit. Vehicle electrical systems having such power circuits that are independent of each other are known to those skilled in the art. For example, an energy accumulator is assigned to each power circuit, the energy accumulator being fed by a common generator. The energy accumulators and the power supply circuits dependent on them are, however, independent of each other. A communication system K is present between the two control modules via which the control modules exchange data with each other and possibly with additional control units which are not shown, for example, central control units.

Control module VA receives signals from actuator 10, specifically from measuring devices 10a, 10b and 10c, the signals representing the wheel braking pressure in left front wheel PRVL, in right front wheel PHSVA as well as the pressure in high-pressure accumulator PHSVA of the front axle actuator. The corresponding notation applies to control module HA which receives the corresponding variables of actuator 12 (see measuring devices 12a to 12c). Via output lines, control module VA activates hydraulic pump HP to charge the hydraulic accumulator of the front axle brake module, as well as the inlet and outlet valves of the right and the left front wheel brakes (EVVL, EVVR, AVVL, AVVR). Similarly, control module HA controls hydraulic pump HP of rear axle actuator 12 as well as the inlet and outlet valves of rear wheel brakes EVHL, EVHR, AVHL and AVHR. Actuator 10 is operated within the first electrical power circuit and actuator 12 is operated within the second electrical power circuit.

The function of the control modules is known from the aforementioned related art. It will therefore only be briefly described in the following. Each control module receives the desired braking values (braking torque, braking force, braking pressure, slip, etc.) for the axle and/or for the respectively assigned wheel brakes via communication system K (in an alternative embodiment via separate line connections). According to a closed control loop provided for each wheel brake or axle, triggering signals are output for the valves as a function of the deviation between the desired value and a measured, estimated, or calculated actual value corresponding to the desired value, the braking pressure in the wheel brake increasing when the inlet valve is activated and decreasing when the outlet valve is activated. Moreover, the high-pressure pump is activated to charge the hydraulic accumulator as a function of the determined accumulator pressure. The pump is preferably activated when the accumulator pressure falls below a specified limit value. The pressure medium is then supplied from the accumulator. As an alternative or as a supplement, the pump is actuated when braking operation with pressure buildup takes place. The pump is then actuated, for example, as a function of pressing the brake pedal. This method of function is the same for control module VA as well as for control module HA.

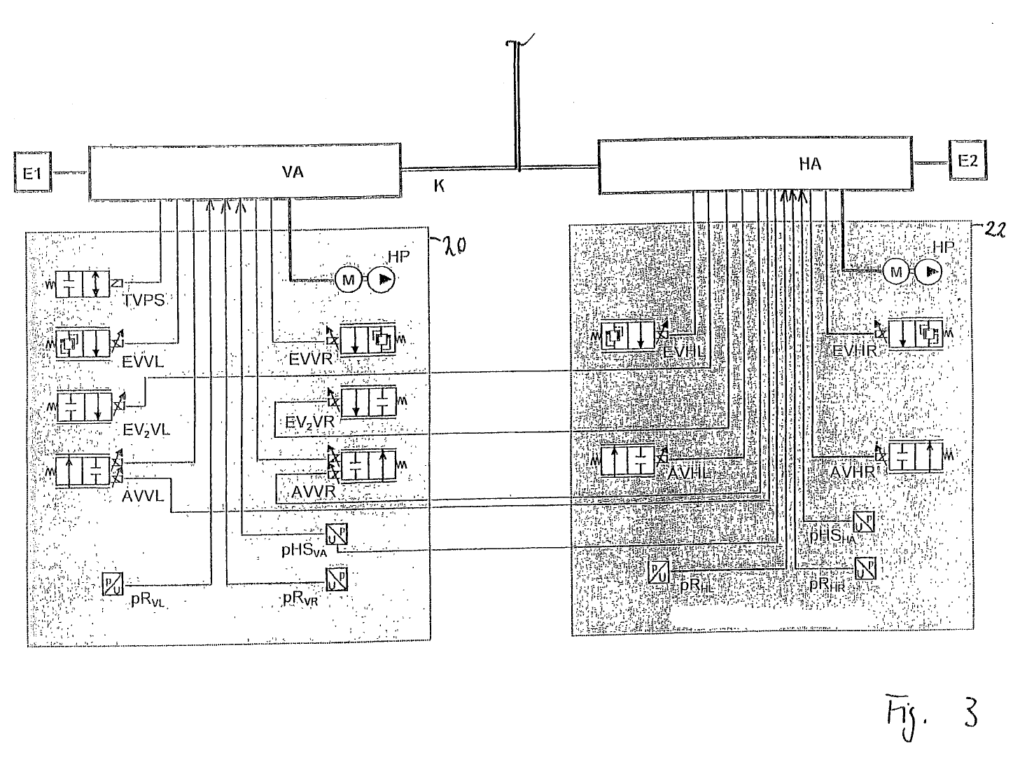

The hydraulic arrangement of at least one of the actuators in FIG. 2 is shown using actuator 10 in FIG. 2 as an example. This hydraulic brake actuator controls the braking pressure in the wheel brakes of right front wheel VR and of left front wheel VL. Actuator 10 and thus the brake circuit of the front axle brakes is completely independent of the brake circuit and actuator 12 at the rear axle. There is no hydraulic connection between the brake circuits, and the actuators are supplied with electrical power by two independent electrical power circuits. If a simple fault exists in the braking system, for example, the failure of an electrical power circuit, a defective high-pressure pump or a leak in the hydraulic circuit, the function of only one of the two brake circuits is ever affected.

In this simplest version of actuator 10 (actuator 12 has an identical design), hydraulic pump HP delivers pressure medium from a reservoir 100 via a non-return valve RV into hydraulic accumulator HS or brake line 102. Sensor PHSVA detects the pressure in the hydraulic accumulator or in the brake line in the area of the accumulator. Brake line 102 leads via the two electrically operable inlet valves EVVR and EVVL for the two wheel brakes to the corresponding wheel brake cylinders. Between each wheel brake cylinder and inlet valve, the return line branches off from the wheel brake line, the return line in each case leading leads back to reservoir 100 via an outlet valve AVVR, AVVL. The pressure in the wheel brake line is detected as wheel brake pressure by measuring devices PRVR and PRVL. In one embodiment, an electrically operable balance valve BV (not shown in FIG. 1) is provided, via which the braking pressure can be balanced in the two wheel brake lines.

To build up pressure in a wheel brake, the connected outlet valve, which is open when de-energized, is closed by an appropriate trigger signal; the inlet valve, which is closed when de-energized, is opened. If pressure is to be maintained, the inlet valve is closed; the outlet valve is opened to reduce pressure. The activation is calculated in a known manner by appropriate programs in the control modules or in the higher-level control units.

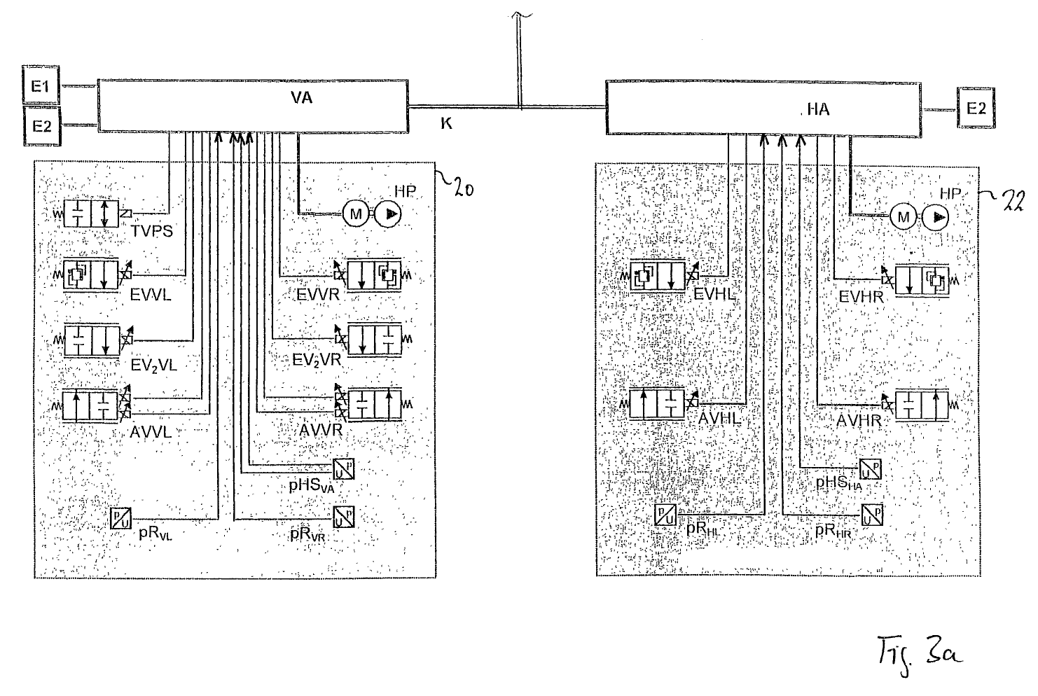

A second embodiment is shown in FIG. 3. This embodiment differs from the one shown in FIG. 1 with regard to the design of the actuator of the front axle as well as the assignment of valve controls to the control modules. The performance range of control modules VA and HA as well as of the rear axle actuator corresponds to the design described above with reference to FIGS. 1 and 2. In addition to the actuator shown in FIG. 1, actuator 20 for the front axle has a shut-off valve TVPS, redundant inlet valves EV2VL, EV2VR connected in parallel to the inlet valves, and outlet valves with the capability of electrically redundant operation. According to the embodiment of FIG. 3, control module VA connected to the first power circuit actuates inlet valves EVVL and EVVR of the front axle wheel brakes, as well as the corresponding outlet valves AVVL, AVVR. Redundant inlet valves EV2VL and EV2VR of front axle actuator 20 are assigned to control module HA. In addition, control module HA can actuate outlet valves AVVL, AVVR of the front axle brakes via the electrically redundant path. Since control module HA is connected to the second power circuit, there is both hydraulic as well as electrical redundance with regard to the front axle. In the event of a failure of the first power circuit, it continues to be possible to build up pressure (from the pressure accumulator) in the front axle brakes, the pressure being controlled from control module HA via the redundant inlet valves and the redundant activation of the outlet valves.

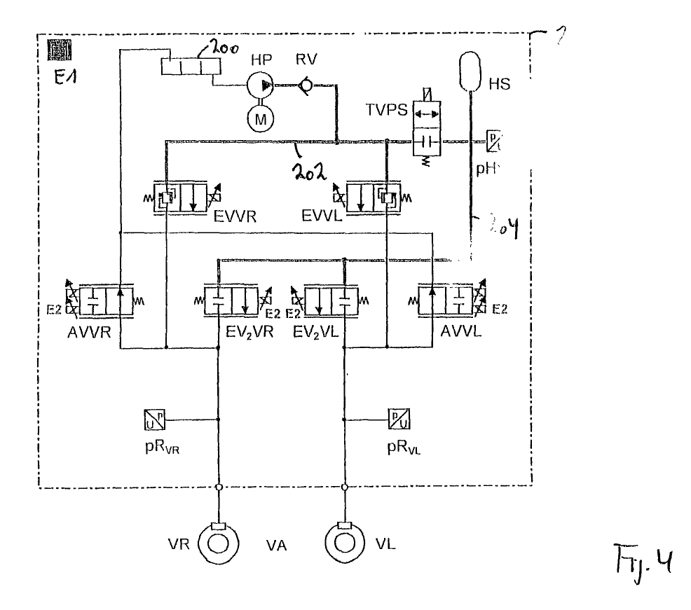

FIG. 4 shows a preferred embodiment of actuator 20. In this case also, a reservoir 200 is provided from which hydraulic pump HP delivers pressure medium via a non-return valve RV. The pump builds up pressure in brake line 202. Brake line 202 is connected to the wheel brakes of the right and left front wheel, respectively, via inlet valves EVVR and EVVL, which are closed when de-energized. Braking pressure PRVR and PRVL, respectively, is detected in the area of these front wheel brakes. Shut-off valve TVP isolates brake line 202 from a redundant branch 204. It is closed when de-energized. The second branch has a hydraulic accumulator HS, sensor PHSVA for the pressure in the hydraulic accumulator, and two redundant inlet valves EV2VR and EV2VL, which are connected hydraulically to the above-described inlet valves which are connected in parallel. These valves are also closed when de-energized. While the first-mentioned inlet valves as well as the shut-off valve are controlled by control module VA and thus supplied from the first power circuit, the redundant inlet valves are controlled by control module HA and thus supplied with power from second power circuit E2. Both branches are combined in one wheel brake line each for each wheel brake. Return lines branch off from these wheel brake lines, the return lines leading back to reservoir 200 via outlet valves AVVR and AVVL, which are open when de-energized. The outlet valves can be actuated from first power circuit E1 as well as from second power circuit E2. This is attained, for example by two independent valve windings or by decoupled redundant control lines.

The actuator shown in FIG. 4 has increased availability. It is preferably used only on the front axle of the braking system. In the proper operating state, valve TVPS, which is closed when de-energized, is open, i.e., energized. When the brake is operated, pressure from high-pressure accumulator HS is fed into the wheel brake circuits via inlet valves EVVR and EVVL. Operation of the outlet valves from control module VA maintains or reduces the pressure. As described above, hydraulic pump HP is activated to again increase the pressure at the time of a braking operation and/or when the accumulator pressure drops. It charges the accumulator via the open shut-off valve. In the event of a fault, e.g., a leak in the accumulator circuit between the shut-off valve, hydraulic accumulator and redundant inlet valves (see brake line 204), the shut-off valve is closed. The leak is detected, for example, by the wheel brake pressure characteristics and/or the accumulator pressure characteristics. The pressure required for a braking operation can then no longer be obtained from the accumulator but rather it is produced by the pump as required by the brake. In contrast to normal operation, the result of this is a reduction of braking pressure buildup dynamics and the loss of the chronological separation between pressure production and wheel brake control; however, the other properties of the braking system such as wheel-individual braking force modulation and maximum attainable pressure level are not adversely affected.

In the event of a failure of first electrical power circuit E1, the shut-off valve is also closed due to the lack of control driving signals. In this case, braking is still performed with the hydraulic energy stored in pressure accumulator HS since the outlet valves and the redundant inlet valves are activated from the second power circuit. This results in increased availability of the front wheel brakes since the actuator and the electrical control ensure that the vehicle can still be braked both in the event of a failure of the electrical power as well as of a leak in a part of the braking system.

An alternative to the structure shown in FIG. 3 is shown in FIG. 3a. The actuators shown in FIGS. 3 and 4 are used. The design of the control modules is different. In the embodiment of FIG. 3a, control module VA is supplied by both power circuits E1 and E2 and is designed, for example, with the aid of the known procedure from the aforementioned related art, in such a way that in the event of a fault of the control module and/or one power circuit, the function is at least partially maintained (fail operational), and at least the continued control of the valves is guaranteed. Thus, in this embodiment, the redundant inlet valves and the redundant electrical operation of the outlet valves are controlled via the second power circuit E2 while the other valves and the other activation path, respectively, are activated from power circuit E1. In the event of a fault of the first power circuit and/or a part of the hydraulic circuit and/or of the control module, control module VA switches to the redundant valve operation from the second power circuit.

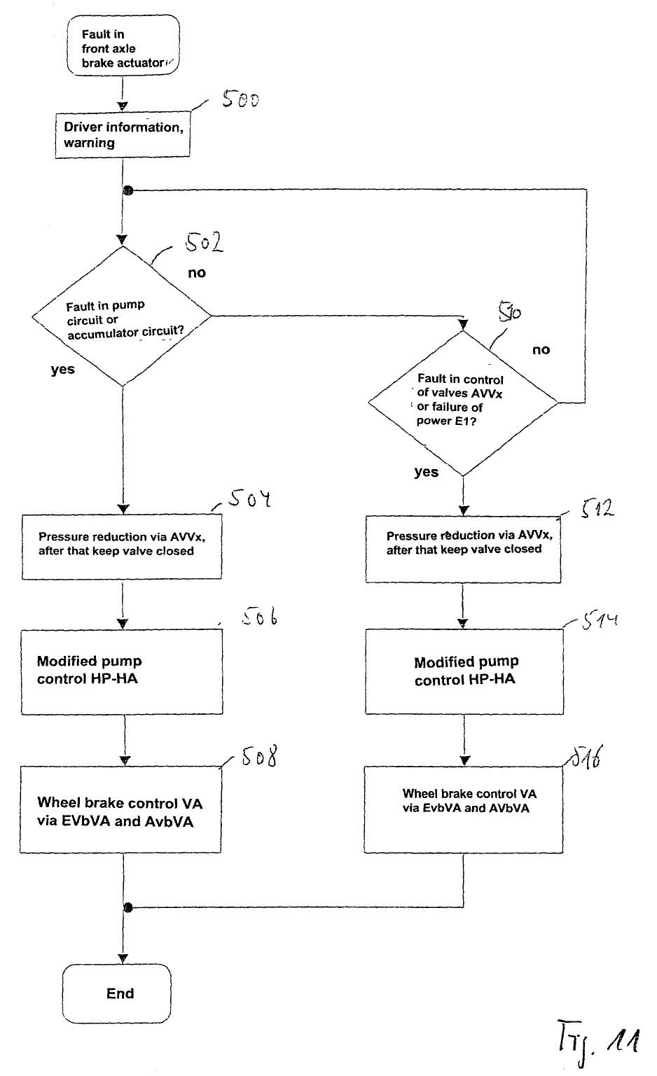

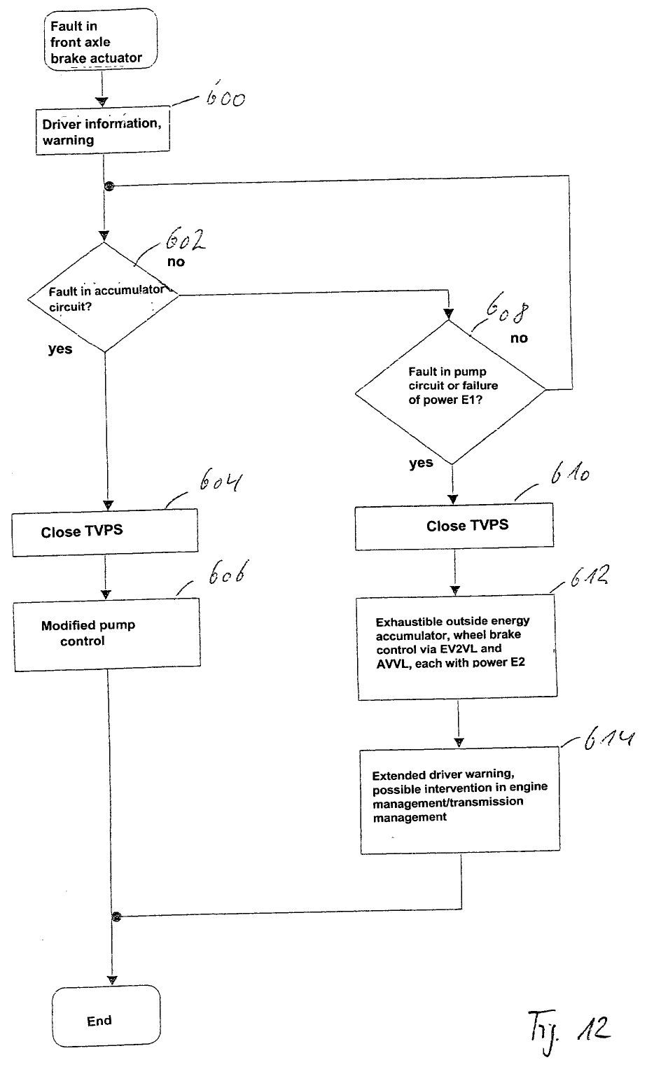

In both embodiments, the second power circuit and the components of the front axle circuit activated from it are not necessary for the front axle brake function. Rather, they represent a backup level which is activated as a function of the recognized faults in the system (see also FIGS. 11 and 12).

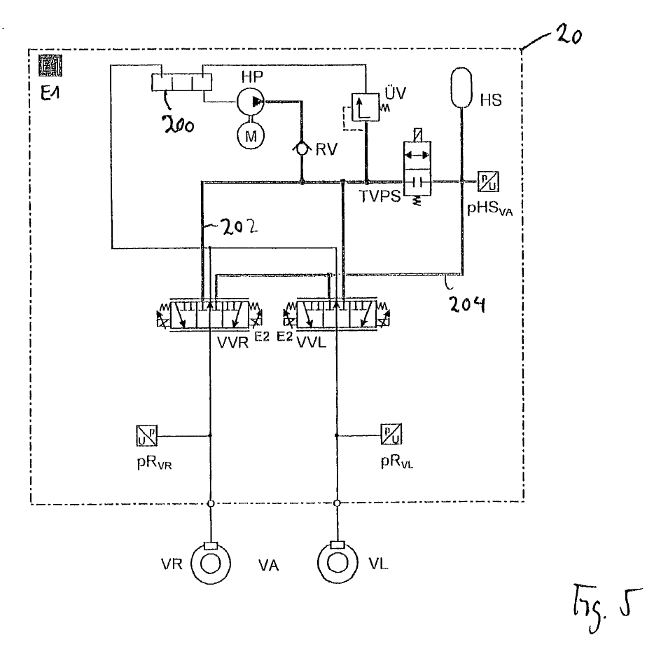

An alternative design of actuator 20 is shown in FIG. 5. Instead of separate inlet and outlet valves, in the embodiment of FIG. 5, three-position valves VVR and VVL are used for each wheel brake, the three-position valves, when de-energized, keeping a return line from the wheel brake to a reservoir 200 open. Depending on the control, the valve is connected either to a first brake line 202 or to a second brake line 204 for pressure buildup, the control in the first-named position taking place from power circuit E1 and in the second-named position from second power circuit E2. Thus this device also brings about a redundance representing a backup level in the event of a fault and ensures the braking of the vehicle even in the event of a fault. The control paths are assigned to control modules VA or HA according to the principles shown in FIG. 3 or 3a, depending on the design of control module VA. An overload valve ÜV leads from the outlet side of the pump into reservoir 200 and relieves the pressure in brake line 202, in particular when the pump is active and the shut-off valve is closed.

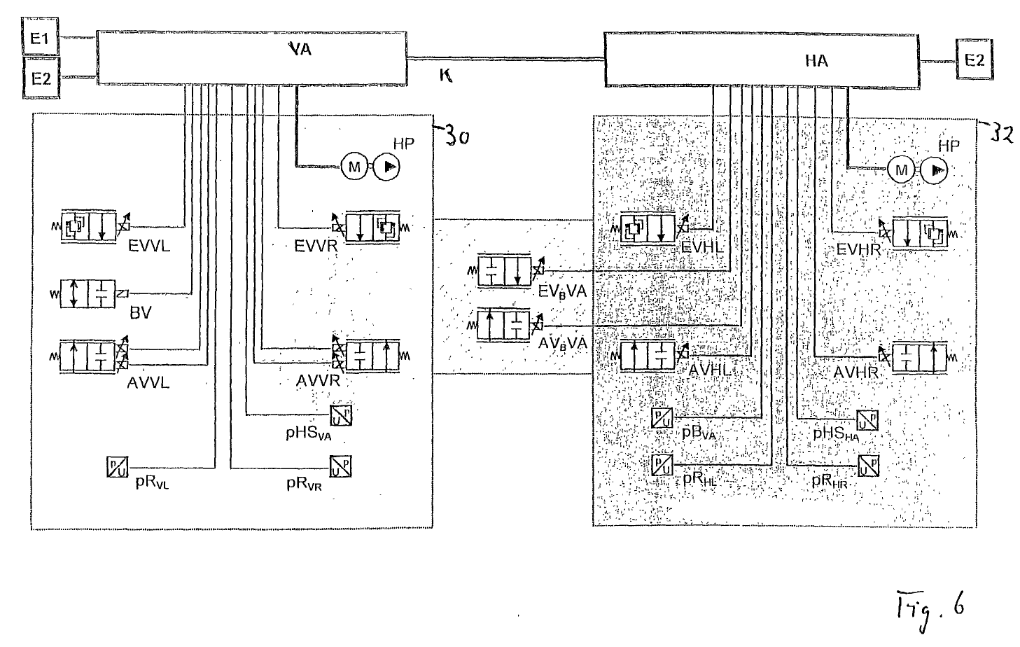

FIGS. 6 to 9 show an additional embodiment. In this case, the increased availability of the front axle braking function is not attained by a partial redundance of the front axle brake actuator, but rather by a rear axle brake actuator expanded by an inlet valve and an outlet valve, the rear axle brake actuator having a hydraulic connection to the front axle brake circuit via at least one media separating piston.

The embodiment of FIG. 6 shows a front axle brake actuator 30 which has simple inlet valves and outlet valves with the possibility of redundant activation, control module VA in the embodiment of FIG. 6 being designed to be fail operational as in FIG. 3a. Control module VA activates the inlet valves and possibly balance valve BV via the first power circuit as well as the outlet valves via a first control path, while from the second power circuit it redundantly activates the outlet valves on the front wheel brakes via the second control path. Actuator 32 of the rear axle includes, in addition to the elements of FIGS. 1 and 2, additional inlet valves and outlet valves EVBVA and AVBVA. An additional pressure sensor PBVA measures the pressure in the brake line in the rear axle actuator which influences the braking pressure at the front axle brakes. In addition to the inlet and outlet valves of the rear wheel brakes, control module HA also activates this additional inlet and outlet valve, and receives the signal PBVA of the pressure sensor in the brake line.

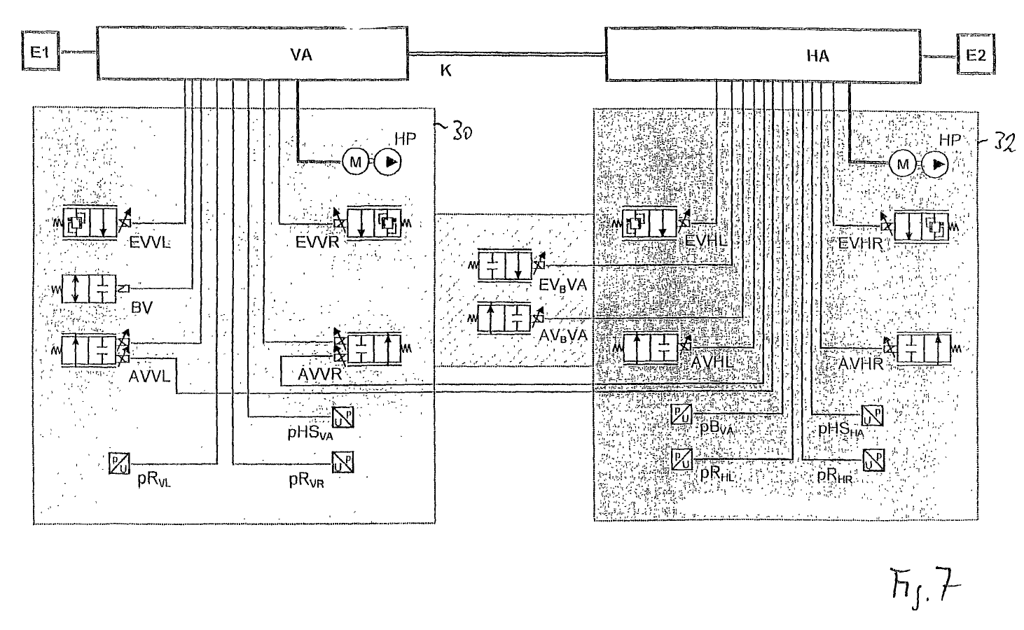

The corresponding description applies to the embodiment of FIG. 7, in this case control module VA only being connected with first power circuit E1. Similarly to FIG. 3, in this case also, the redundant activation of the outlet valves of the front axle actuator is supplied from the second power circuit via control module HA.

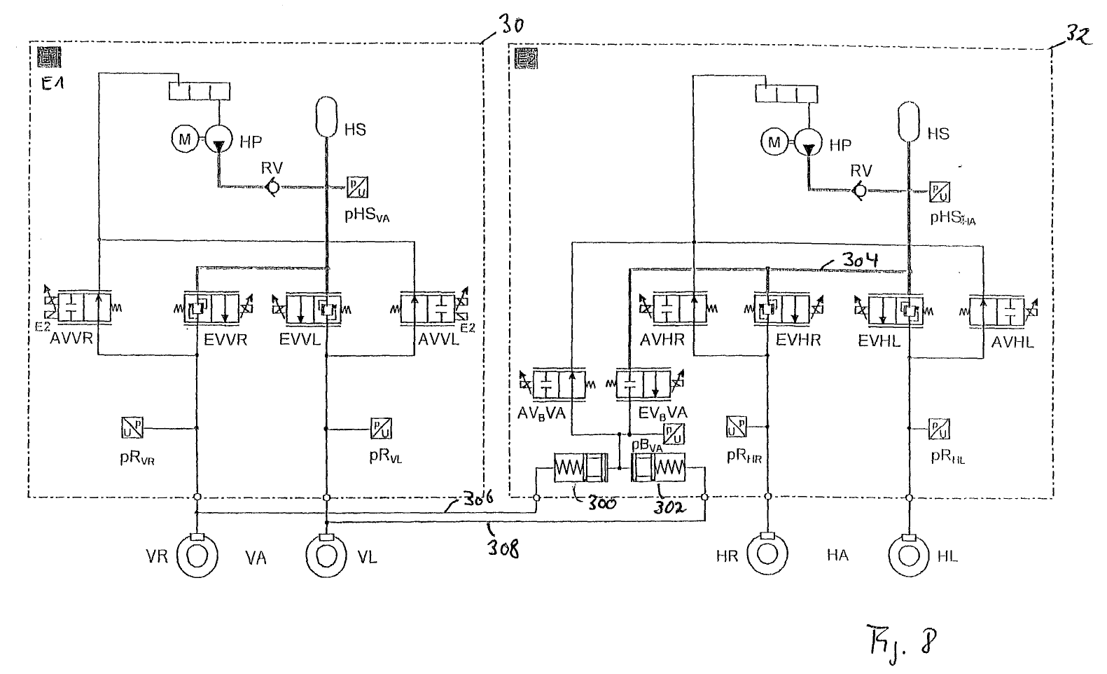

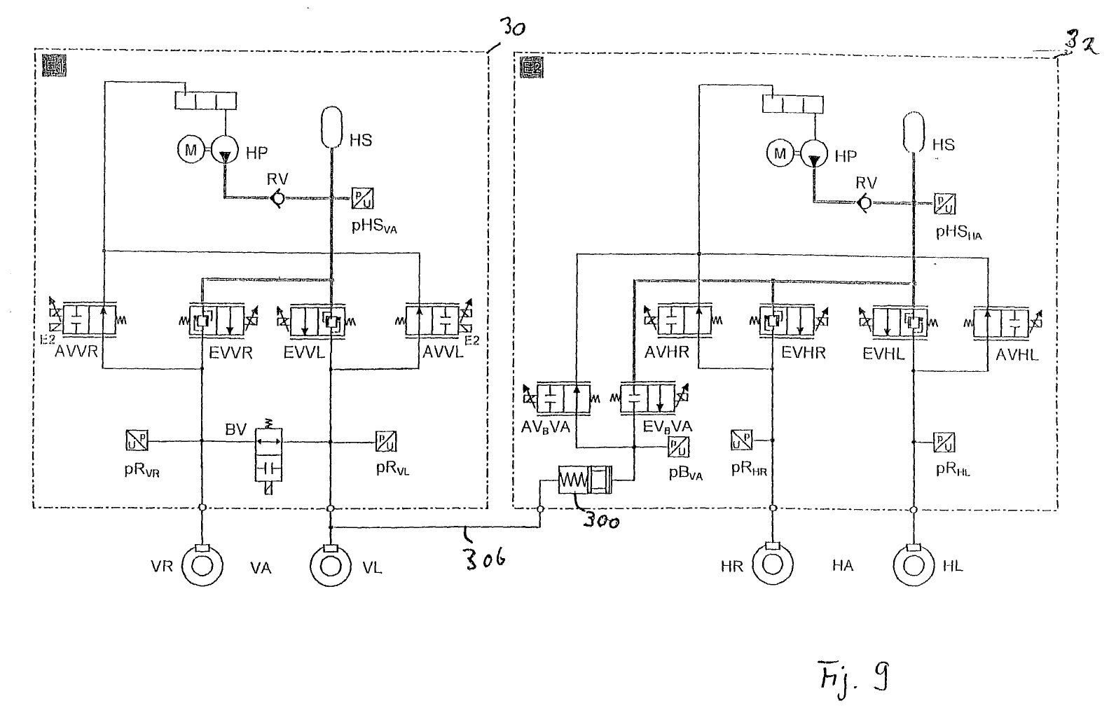

Two exemplary embodiments of actuators 30 and 32 are shown in FIGS. 8 and 9. The design of actuator 30 corresponds to the design of actuator 10 with the exception of the outlet valves which correspond to the valves of actuator 20. The rear wheel actuator, which also corresponds to actuator 10, is expanded by valves AVBVA and EVBVA as well as pressure sensor PBVA and media separation pistons 300 and 302. Brake line 304 of actuator 32 leads from the hydraulic accumulator or the pump to the inlet valves of the rear axle wheel brakes and to additional inlet valve EVBVA. The latter is closed when de-energized and in the open condition applies the pressure in brake line 304 to media separating pistons 300 and 302. The pressure in the area of the lines applying pressure to the media separating pistons is measured by pressure sensor PBVA. The media separating pistons transfer the inlet pressure to brake lines 306 and 308, which lead to the wheel brakes of the right and left front wheel, respectively. Similarly, a return line branches off from the brake line between the media separating pistons and the additional inlet valve, the return line opening into the return line of the rear axle modulator and thus into the reservoir via an additional outlet valve AVBVA, which is open when de-energized. Thus in the embodiment of FIG. 8, operation of the front wheel brakes via an additional inlet valve assigned to the rear axle actuator is made possible as a backup level if the front axle brake actuator or its power circuit E1 fails. The operation takes place as a function of the setpoint signal with consideration of actual pressure signal PBVA with corresponding actuation of the inlet valve and outlet valve. The additional valves are actuated by control module HA if fault information is present in the control module which was transmitted from control module VA via communication system K. A redundance is thus provided, with no separate controls for individual wheels being provided as a result of the only one inlet valve. As an alternative, the redundant inlet valves of the second embodiment are assigned to the rear wheel actuator in an additional embodiment so that in this case, individual control of the front wheel brakes is possible.

An additional embodiment of the actuators is shown in FIG. 9. Front axle actuator 30 corresponds to the one shown in FIG. 8 while rear axle actuator 32 has only one media separator 300 and one hydraulic connecting line 301 for the brake line of a front wheel brake. In order to guarantee bilateral braking at the front axle even in the event of a fault, a balance valve BV is provided which balances the pressure in the two front wheel brakes. In the event of a fault, for example, of a failure of the electronic system, this balance valve is de-energized so that the brake lines of the two front wheel brakes are connected. Via the additional hydraulic connection 306, it is therefore possible to activate the front wheel brakes via the rear axle brake actuator as a function of the operation of the brake pedal. Interventions individual to each wheel are not possible with this type of emergency operation.

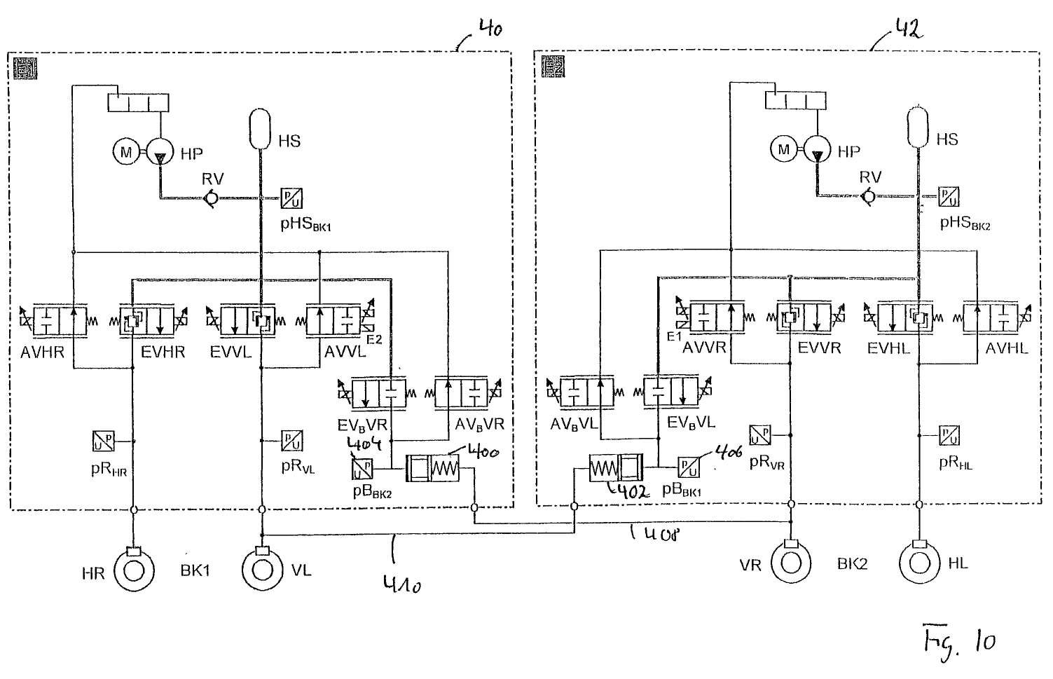

A further version of the actuators is shown in FIG. 10. This version is suitable for a diagonal division of the brake circuit. First actuator 40, the valves of which are actuated by a first control module from the first power circuit, controls a front wheel brake and the rear wheel brake arranged diagonally to it, while actuator 42, the valves of which are actuated by a second control module from second power circuit E2, activates the opposite diagonal. Actuator 40 includes supplemental valves EVBVR and AVBVR as well as media separator 400, while actuator 42 contains supplemental valves EVBVL and AVBVL as well as media separator 402. Also present are pressure sensors 404 (actuator 40) and 406 (actuator 42), which detect the pressure in the brake line between the supplemental valves of the respective actuator and the respective media separator. This pressure is referred to as brake circuit pressure PBK2 and PBK1, respectively. Hydraulic lines 408 and 410 lead from media separators 400 and 402, respectively, to the respective front wheel brake lines of the other brake circuit. In the event of a fault, when, for example an actuator or an electrical power circuit fails, the front wheel brake assigned to this power circuit or actuator is controlled according to the valve operations of the supplemental valves of the other actuator as a function of the specified setpoint pressure and the brake circuit pressure detected by sensors 404 and 406, respectively. An emergency operation possibly with individual control for each wheel of the front wheel brakes is therefore possible. Thus an appropriate design of the actuators in a diagonal brake circuit division preserves the braking function in both wheels of the front axle in the event of a simple fault in the system. If there is a fault in one brake circuit, both wheels of the front axle and one wheel on the rear axle are braked with the aid of the hydraulic actuator of the second brake circuit. With the division of the actuators according to FIG. 10, all components of actuator 40 are supplied by the first power circuit and all components of actuator 42 are supplied by the second power circuit.

Programs running in the control modules, in the at least one computing unit of the control modules, are provided to initiate the emergency operation and for the corresponding control of the actuators. Fault values are detected in one embodiment corresponding to the procedure known from the related art.

FIG. 11 shows a flow chart which is an exemplary embodiment of such a program in the context of the embodiment shown in FIGS. 6 to 9. The flow chart shows a program which runs in the computing unit of control module HA. The program shown is started when a fault in the front axle brake actuator is reported to control module VA via communication system K. In a design which is not “fail operational,” the output of control driving signals by control module VA is interrupted if faults occur in the pump circuit or accumulator circuit or power circuit. In preferred embodiments, the recognition of faults in the hydraulic and/or electrical circuit is determined according to methods that are known from the related art. If a fault in the area of the front axle brake circuit is thus transmitted to control module HA, the driver is informed and/or warned in first step 500, for example, visually (warning light), acoustically, etc. Subsequently, in step 502, a query is made on the basis of the transmitted fault information as to whether a fault is present in the pump circuit or accumulator circuit of the front axle brake actuator. If this is the case, in step 504, control module HA outputs a control driving signal for reduction of the pressure in the front axle wheel brakes via the outlet valves of the front axle actuator. In the embodiment of FIG. 7, this takes place by appropriate activation of outlet valves AVVR and AVVL via the redundant activation path. In the embodiment according to FIG. 6, this step is taken by front axle control module VA itself. The outlet valves of the front axle actuator are then kept closed. Subsequently, in step 506, control module HA initiates modified control of hydraulic pump HP. Since this pump, in addition to the rear axle brake circuit, at least in part additionally supplies the front axle brake circuit with hydraulic fluid and brake pressure, the speed, for example, of the rear axle module hydraulic pump or the maximum pressure produced by it is increased. Subsequently, in step 508, as described above, the brake control at the front axle is implemented via additional inlet and outlet valves EVBVA and AVBVA. After that the program is terminated, steps 504 to 508 being repeated as long as the vehicle is in operation.

If it was recognized in step 502 that no fault was present in the pump circuit or accumulator circuit, a check is made in step 510 as to whether the fault is present in the control of the outlet valves or in the electrical power circuit, in particular a failure of power E1. If this is not the case, no emergency operation is initiated (control module VA continues to control the front axle brakes) and the program is repeated with step 502. If step 510 showed that such a fault was present, then in step 512, the outlet valves on the front axle are energized for pressure reduction and thereafter the control of the outlet valves is switched off. In the following steps 514 and 516, the pump activation in the rear axle actuator and the wheel brake control of the front axle is modified via the rear axle actuator corresponding to steps 506 and 508.

FIG. 12 shows an embodiment for emergency operation in a design of the control system according to one of the embodiments of FIGS. 3 to 5. The program shown in FIG. 12 runs in control module VA of the front axle brake circuit. In this case also, the program is started if a fault is detected in the front axle brake actuator, which is determined by appropriately set flags. Subsequently, as mentioned above, the driver is informed or warned in step 600. In the subsequent step 602, a check is made as to whether a fault has occurred in the accumulator circuit of the front axle brake circuit, for example, a leak, a pump failure, etc. If this is the case, shut-off valve TVPS is closed in step 604 and after that, the activation of the hydraulic pump is modified in step 606 as appropriate; in particular, the pump is activated every time a braking operation is present and is not switched off again until the braking operation is completed since there is no supply with pressure medium from hydraulic accumulator HS. After that, the program is terminated and repeated with step 604.

If step 602 showed that no fault was present in the accumulator circuit, a check is made in step 608 as to whether a fault is present in the pump circuit, for example, a pump failure or a failure of power E1. If this is not the case, the program is repeated with step 602 and no emergency operation is initiated but rather the system continues in normal operation. If this is the case, in step 610, the shut-off valve is closed and in step 612, the supply of braking pressure solely originates from the hydraulic accumulator. Wheel brake control then takes place via supplemental valves EV2VR and EV2VL, and the redundant activation of outlet valves AVVR and AVVL with the power of second power circuit E2, either from control module HA or, in the “fail operational” design, via control module VA. Thereupon, an additional warning is output in step 614 by a warning light and/or a fault message to the driver and, in one embodiment, an intervention is made into the engine management and/or transmission management for the purpose of limiting the speed of the vehicle. After that, the program is terminated and restarted.

What is claimed is:

1. A method for controlling wheel brakes in an electrical braking system of a motor vehicle, comprising the steps of:
generating control driving signals for valve arrangements for a control of a braking pressure in a first group of the wheel brakes from a first power circuit and for a control of a braking pressure in a second group of the wheel brakes from a second power circuit that is independent of the first group of the wheel brakes; and
detecting a first fault in an area of at least one of the valve arrangements, a pressure supply, and an electrical system of the electrical braking system, wherein:
when a second fault affects those of the wheel brakes supplied by the first power circuit, the control driving signals for one of the valve arrangements are generated, a power for an activation of the one of the valve arrangements originating from the second power circuit.

2. A method for controlling wheel brakes in an electrical braking system of a motor vehicle, comprising the steps of:
generating control driving signals for valve arrangements for a control of a braking pressure in one of the wheel brakes from a first power circuit, a braking pressure being provided by at least one of an accumulator and a pump; and
detecting a first fault in an area of at least one of the valve arrangements, a pressure supply, and an electrical system of the electrical braking system, wherein:
when a second fault occurs in one of an accumulator circuit, a pump circuit, and the first power circuit, a valve is activated at a brake actuator of a front one of the wheel brakes, the valve isolating the pump circuit from the accumulator circuit.

3. The method according to claim 1, wherein:
when a fault condition occurs, the control driving signals are generated to actuate at least one of additional valve arrangements and existing valve arrangements via a redundant electrical control on the basis of the power of the second power circuit.

4. The method according to claim 1, wherein:
in a fault condition of one of the wheel brakes, a speed of the motor vehicle is limited.

5. The method according to claim 2, wherein:
in a fault condition of one of the wheel brakes, a speed of the motor vehicle is limited.

6. The method according to claim 1, wherein:
in a fault condition in an area of a front axle brake actuator, a braking pressure control occurs in front ones of the wheel brakes according to control driving signals generated from a control module assigned to one of rear ones of the wheel brakes.

7. The method according to claim 2, wherein:
in a fault condition in an area of a front axle brake actuator, a braking pressure control occurs in front ones of the wheel brakes according to control driving signals generated from a control module assigned to one of rear ones of the wheel brakes.

8. The method according to claim 1, wherein:
when a fault condition occurs, control driving signals of a control module of those of the wheel brakes corresponding to rear axle brakes are generated to activate additional valve arrangements via which a braking pressure in those of the wheel brakes corresponding to front wheel brakes is set.

9. A computer program for causing a computing unit of a control unit to perform the steps of:
generating control driving signals for valve arrangements for a control of a braking pressure in a first group of wheel brakes from a first power circuit and for a control of a braking pressure in a second group of the wheel brakes from a second power circuit that is independent of the first group of the wheel brakes; and
detecting a first fault in an area of at least one of the valve arrangements, a pressure supply, and an electrical system of an electrical braking system, wherein:
when a second fault affects those of the wheel brakes supplied by the first power circuit, the control driving signals for one of the valve arrangements are generated, a power for an activation of the one of the valve arrangements originating from the second power circuit.
